(19) United States
(12) Patent Application Publication
(10) Pub. No.: US 2019/0253852 A1
(43) Pub. Date: Aug. 15, 2019

(54) Method and its Module for Handling its Message

(71) Applicant: Telefonaktiebolaget LM Ericsson (publ), Stockholm (SE)

(72) Inventors: Lisa BOSTRÖM, SOLNA (SE); Tomas NYLANDER, VÄRMDÖ (SE); Stefan RUNESON, LUND (SE)

(21) Appl. No.: 16/342,004

(22) PCT Filed: Oct. 20, 2016
(86) PCT No.: PCT/SE2016/051022

§ 371 Date: Apr. 15, 2019

(51) Int. Cl. H04W 4/44; H04L 29/06

(52) U.S. Cl. CPC H04W 4/44; H04W 88/06; H04L 69/08

(57) ABSTRACT

A method and an Intelligent Transportation System “ITS” module (110) for handling an ITS message are disclose. The ITS module (110) is configured for sending the ITS message over at least one of a second ITS station interface and a first ITS station interface towards an ITS station (121) and over an ITS server interlace to an ITS server (130). The ITS module (110) receives (A040) information relating to the ITS message over the second ITS station interface or the ITS server interface. Then, the ITS module (110) determines (A060) to send the ITS message over at least the first ITS station interface when the information relating to the ITS message was received over the second ITS station interface or the ITS server interface. Next, the ITS module (110) sends (A070), towards the ITS station (121), the ITS message over said determined at least the first ITS station interface. A corresponding computer program and a computer program carrier are also disclosed.

### TECHNICAL FIELD

Embodiments herein relate to Intelligent Transport Systems (ITS), such as Cooperative-Intelligent Transport Systems or the like. In particular, a method and an ITS module for handling an ITS message are disclosed. A corresponding computer program and a computer program carrier are also disclosed.

### BACKGROUND

Intelligent Transport Systems (ITS) deal with services for facilitating transportation in a transportation infrastructure, such as a road system, a railway system and the like. Within ITS, a special domain of systems are referred to as Cooperative-Intelligent Transport Systems (C-ITS). Typically, C-ITS provide support for improved safety and more efficient usage of the transportation infrastructure for transportation of goods and humans over any transportation means.

ITS services, protocols and connectivity solutions are described in specifications issued by standardization bodies like Institute of Electrical and Electronics Engineers (IEEE), Society of Automotive Engineers (SAE), European Telecommunications Standards Institute (ETSI) and International Organization for Standardization (ISO). In addition to the mentioned standards, the C-ITS architecture is described and developed in research collaborations like COmmunication Network VEhicle Road Global Extension (CONVERGE), Nordic Way and in consortiums of automobile manufacturers, suppliers and research organizations, like European Road transport Telematics Implementation COordination (ERTICO) and Car-2-Car Communication Consortium

A known C-ITS comprises various entities, such as one or more vehicles, one or more traffic lights, road signs and the like, and a server providing an ITS service for handling e.g. map and traffic information.

Furthermore, a so called On Board Unit (OBU) provides communication capability to vehicles and the like. An OBU can also be carried by a pedestrian, in which case the OBU typically is included in a smartphone. Communication between the pedestrian and e.g. a vehicle may be referred to as Vehicle-to-Pedestrian (V2P) communication.

Generally, traffic lights, road signs etc., that are included in the C-ITS, are referred to as Road Side Units (RSUs). An RSU has two primary functions 1) to send Vehicle-to-Infrastructure (V21) messages with information to OBUs, e.g. Signal Phase and Timing (SPAT) messages for connected traffic lights, and 2) to forward multi-hop Vehicle-to-Vehicle (V2V) messages to OBUs and other RSUs to extend coverage area for those V2V messages.

In order to provide a wireless technology for communication between e.g. vehicles and infrastructure, it has been proposed to use Dedicated Short Range Communication (DSRC), cellular Third Generation Partnership Project (3GPP) technologies, or a 3GPP based technology referred to as Long Term Evolution (LTE) Vehicle-to-Everything (V2X). The DSRC technology includes ETSI ITS G5, IEEE Wireless Access in Vehicular Environments (WAVE). These technologies, providing communication between e.g. vehicles and infrastructure, are referred to as ITS technologies herein.

Some application level messages, often referred to as ITS messages, are the same in ETSI ITS G5 and IEEE WAVE as shown in Table 1. Examples of such application level messages are Cooperative Awareness Message (CAM), Decentralized Environmental Notification Message (DENM), Basic Safety Message (BSM), Signal Phase and Timing (SPAT), Mapdata Messages (MAP), HyperText Transfer Protocol (HTTP), File Transfer Protocol (FTP) and the like. Similarities and differences between ETSI ITS G5 and IEEE WAVE are illustrated in Table 1.

TABLE 1
DSRC protocol stacks exemplified
by ETSI ITS G5 and IEEE WAVE

| ETSI ITS G5 | | IEEE WAVE | |
|---|---|---|---|
| CAM/DENM | HTTP/FTP | BSM/SPAT/MAP | HTTP/FTP |
| BTP | UDP/TCP | WSMP | UDP/TCP |
| GeoNetworking | IPv6 | 1609.3 | IPv6 |

| | |
|---|---|
| 802.2 LLC | 802.2 LLC |
| DCC | 1609.4 |
| 802.11p MAC | 802.11p MAC |
| 802.11p PHY | 802.11p PHY |

Legend
BSM Basic Safety Message
BTP Basic Transport Protocol
CAM Cooperative Awareness Message
DCC Decentralized Congestion Control
DENM Decentralized Environmental Notification Message
FTP File Transfer Protocol
GeoNetworking Network layer protocol that provides packet routing based on geographical positions
HTTP HyperText Transfer Protocol
IPv6 Internet Protocol Version 6
LLC Logical Link Control
MAC Medium Access Control
MAP Mapdata Messages
PHY Physical Layer
SPAT Signal Phase and Timing
UDP/TCP User Datagram Protocol/Transmission Control Protocol
WSMP WAVE Short Message Protocol

Concerning LTE V2X, 3GPP has started standardization activities. A benefit of LTE V2X is the possibility to reuse installed LTE network equipment as well as installed LTE communication equipment in vehicles.

In view of the above, it is expected that different technologies will be used in different regions, such as different countries or the like.

In the following scenario, a vehicle comprises an OBU with DSRC, i.e. either ETSI ITS G5 or IEEE WAVE. The vehicle interoperates with other vehicles and infrastructure in a region. However, as technologies evolve, it is decided that the region should switch to LTE V2X. During an interim period, vehicles with both DSRC and LTE V2X would be allowed and would need to co-exist in the region. A disadvantage is though that a message from a vehicle supporting DSRC may not be handled by a vehicle supporting LTE V2X.

### SUMMARY

An object may be to overcome, or at least alleviate, the above mentioned disadvantage in an ITS system of the above mentioned kind.

According to an aspect, the object is achieved by a method, performed by an ITS module for handling an ITS message. The ITS module is configured for sending the ITS message over at least one of a first ITS station interface and a second ITS station interface towards an ITS station. The ITS module further is configured for communicating with an ITS server over an ITS server interface. The ITS module receives information relating to the ITS message over the second ITS station interface or the ITS server interface. The ITS module determines to send the ITS message over at least the first ITS station interface when the information relating to the ITS message was received over the second ITS station interface or the ITS server interface. Furthermore, the ITS module sends, towards the ITS station, the ITS message over said determined at least the first ITS station interface.

According to another aspect, the object is achieved by an ITS module configured for handling an ITS message. The ITS module is configured for sending the ITS message over at least one of a first ITS station interface and a second ITS station interface towards an ITS station. The ITS module further is configured for communicating with an ITS server over an ITS server interface. The ITS module is configured for receiving information relating to the ITS message over the second ITS station interface or the ITS server interface. The ITS module is configured for determining to send the ITS message over at least the first ITS station interface when the information relating to the ITS message was received over the second ITS station interface or the ITS server interface. Furthermore, the ITS module is configured for sending, towards the ITS station, the ITS message over said determined at least the first ITS station interface.

According to further aspects, the object is achieved by a computer program and a computer program carrier corresponding to the aspects above.

The ITS module determines to use said at least the first ITS station interface when the information relating to the ITS message was received over the second ITS station interface or the ITS server interface. In this manner, it is ensured that the ITS message is sent over said at least the first ITS station interface that may be different from the second ITS station interface. Therefore, the ITS station implementing e.g. only the first ITS station interface may receive the ITS message even though it was transmitted using another interface, such as the second ITS station interface or the ITS server interface.

An advantage is that interworking between different ITS technologies, e.g. accessible via the first and second ITS station interfaces, is enabled.

### BRIEF DESCRIPTION OF THE DRAWINGS

Various aspects of embodiments herein, including particular features and advantages thereof, will be readily understood from the following detailed description and the accompanying drawings, in which:

FIG. 1 is a schematic overview of an exemplifying system in which embodiments herein may be implemented,

FIG. 2 is a combined signaling and flowchart illustrating the methods herein,

FIG. 3 is a block diagram illustrating embodiments of the ITS module,

FIG. 4 is a further schematic overview illustrating an example in which an ITS message is handled by an ITS server, and

FIG. 5 is a flowchart illustrating the method performed by the system of FIG. 4.

### DETAILED DESCRIPTION

Throughout the following description similar reference numerals have been used to denote similar features, such as actions, modules, circuits, parts, items, elements, units or the like, when applicable. In the Figures, features that appear in some embodiments are indicated by dashed lines.

In order to further illustrate advantages and benefits of the embodiments herein, the following scenario may be considered. An OBU, such as a vehicle or the like, with DSRC is associated with a first region in which DSRC is implemented in RSUs and the like. The OBU moves to a second region, in which e.g. LTE V2X is used by OBUs associated with the second region. These OBUs, associated with the second region, do not use DSRC that is implemented in the OBU of the first region. A problem may then for example be that an ITS message sent from the OBU of the first region may not reach, i.e. become processed by, OBUs of the second region. Additionally, the OBU may not receive, i.e. be able to process, ITS messages from OBUs of the second region.

In the following some further background information is provided in order to better appreciate the embodiments herein.

In the United States (US), there are legislative proposals for mandating DSRC in new vehicles manufactured from 2019. Also, considering there have already been several V2X trials using DSRC-based technology, as well as that there are commercial products available, it may even be so that DSRC technology would be deployed initially and then possibly replaced by LTE and/or 5G at a later stage. In such case, there would be an interim period when both technologies co-exist. Considering that vehicles need to be adapted to be compatible with a certain technology, the interim period would probably be quite extensive since vehicles are not expected to be replaced by car owners merely in order to obtain support for a new upcoming technology. Moreover, replacement of parts in an existing vehicle in order to obtain support for such new upcoming technology would likely be costly. In addition, it is also believed that it would be difficult to achieve high penetration for such replacement unless the replacement would be mandated by law in some way.

In view of Table 1 above, it may be noted that both versions use the same Physical layer and Media Access Control (MAC) layer. It is IEEE 802.11p standard, i.e. an amendment to the IEEE 802.11, for wireless access in vehicular environments. Higher layer protocols are typically different in ITS G5 and WAVE, and different functions are sometimes solved on different layers as shown in Table 2 below.

TABLE 2
Functions implemented on different layers in ITS G5 and WAVE

| Function | ETSI ITS G5 | IEEE WAVE |
|---|---|---|
| Congestion control | Data link layer | Application layer |
| | Decentralized | Basic Safety |
| | Congestion Control (DCC) | Message (BSM) |
| Geo networking | Network layer | Application layer |
| | GeoNetworking | Similar function as |
| | protocol | ETSI ITS G5 |
| Retransmission | Application layer | Application layer |
| | Periodic | Periodic |
| | transmission | transmission |
| Security | Application layer | Application layer |
| | Signed message and | Signed message |
| | PKI certificate | and PKI certificate |
| | transmitted in every | transmitted in every |
| | message | message |

Now turning to LTE V2X again, an overview of some activities concerning standardization is provided in Table 3 below.

| Group | Type | Title | Ready | Reference | Report |
|---|---|---|---|---|---|
| RAN | SI | Feasibility Study on | June 2016 | RP- | TR |
| | | LTE-based V2X | | 151109 | 36.885 |
| | | Services | | | |
| RAN | WI | Support for V2V | September | RP- | |
| | | services based on | 2016 (core) | 152293 | |
| | | LTE sidelink | March 2017 | | |
| | | | (perf) | | |
| SA1 | SI | Study on LTE | Close to | SP- | TR |
| | | support for | ready | 150051 | 22.885 |
| | | V2X services | | | |
| SA2 | SI | Study on | June 2016 | SP- | |
| | | architecture | | 150625 | |
| | | enhancements for | | | |
| | | LTE support of | | | |
| | | V2X services | | | |
| SA3 | SI | Study on security | September | SP- | |
| | | aspects for LTE | 2016 | 150715 | |
| | | support of V2X | | | |
| | | services | | | |

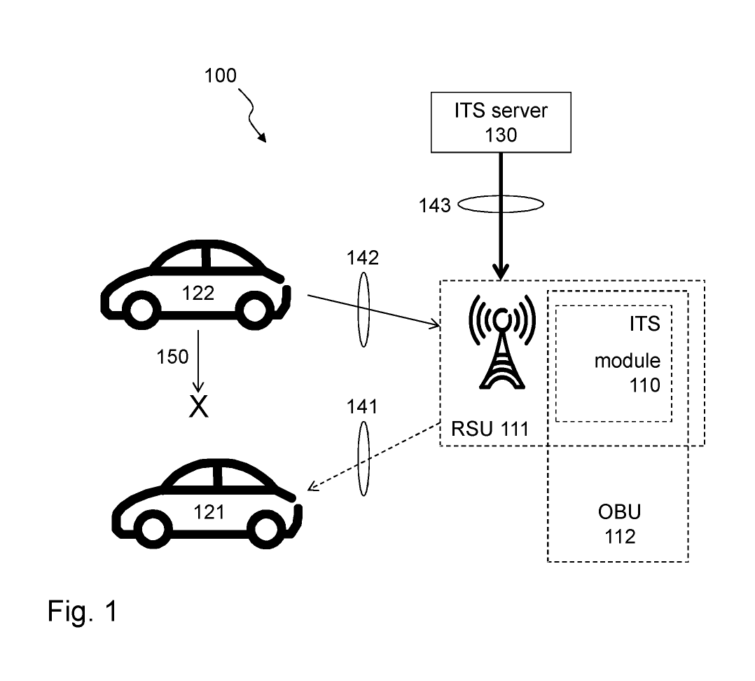

FIG. 1 depicts an exemplifying system 100 in which embodiments herein may be implemented. In this example, the system 100 is an ITS system, such as a C-ITS system or the like.

The ITS system may comprise, e.g. rely at least in part on, any cellular, wireless or wired communication system, such as LTE, Universal Mobile Telecommunication System (UMTS), IEEE 802.11p and Worldwide Interoperability for Microwave Access (WiMAX) or the like.

The system 100 may be said to comprise an ITS module 110, which may be comprised in a Road Side Unit (RSU) 111. This may mean that the ITS module 110 is implemented in the RSU 111.

Moreover, the system 100 be said to comprise an ITS station 121 and a further ITS station 122, each of which may be hosted in a respective vehicle. The ITS station 121 and the further ITS station 122 may implement a respective On Board Unit (OBU), while using terminology known from e.g. ETSI specifications.

In this context, it may be noted that the ITS module 110 may be implemented in an OBU 112. Hence, as an example, the ITS module 110 may be comprised in a further vehicle (not shown) instead of the RSU 111 as shown in FIG. 1. The further vehicle thus comprises a yet further ITS station that may implement the OBU 112, including the ITS module 110.

Furthermore, the system 100 may be said to comprise an ITS server 130, which may be executing on a server machine or as a service in a cloud platform.

Upon operation of the system 100, the ITS module 110 may communicate with the ITS station 121 over only a first ITS station interface 141, since the ITS station 121 is configured to support communication over only the first ITS station interface associated with a first ITS technology.

In addition, the ITS module 110 may communicate with the further ITS station 122 over only a second ITS station interface 142, since the further ITS station 122 is configured to support communication over only the second ITS station interface associated with a second ITS technology. Typically, the first ITS technology is different from the second ITS technology. The first and second ITS technologies may be any direct communication technology, such as DSRC, LTE V2X PC5 or the like. Moreover, the first ITS technology may be associated with a first protocol stack and the second ITS technology may be associated with a second protocol stack. The first protocol stack may be different from the second protocol stack at least in terms of physical layer.

In view of the above, it is clear that the ITS station 121 cannot receive 150 ITS messages directly from the further ITS station 122, since the ITS station 121 and the further ITS station 122 supports different ITS interfaces, i.e. the first and second ITS interface, respectively.

The RSU 111 may be referred to as a multi-mode RSU, since it includes the ITS module 110 that is capable of communicating over both the first and second ITS station interfaces 141, 142.

Furthermore, the ITS module 110 may communicate with the ITS server 130 over an ITS server interface 143, such as a backhaul interface. The ITS server interface may use any known communication technology, e.g. based on Transport Control Protocol/Internet Protocol (TCP/IP) or the like.

According to ETSI TS 102.792 V1.2.1 (2015-06), an ITS station, in general, may be
fixed, mounted at a fixed geographical position, often close to a road or street (roadside ITS stations),
mobile, mounted in vehicles (vehicle ITS stations), or
personal, integrated in smart phones or other personal equipment.

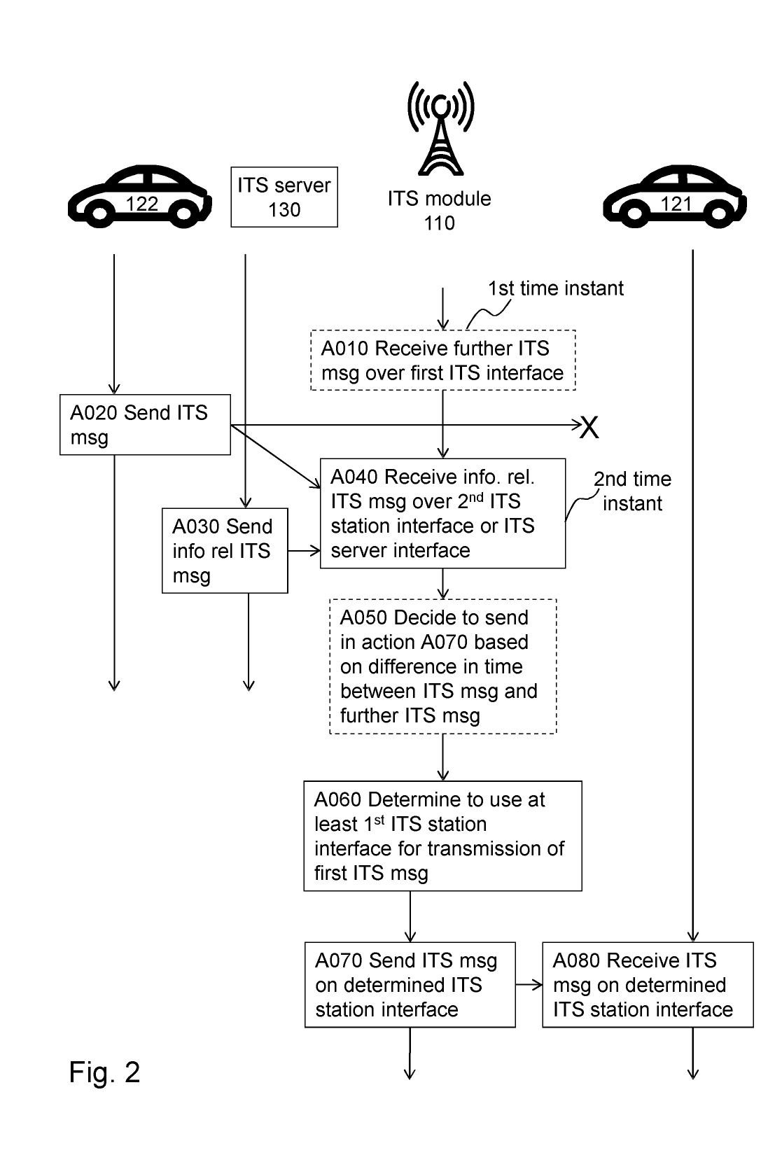

FIG. 2 illustrates an exemplifying method according to embodiments herein when implemented in the system 100 of FIG. 1.

The ITS module 110 performs a method for handling an ITS message. As described above, the ITS module 110 is capable of communicating with both the ITS station 121 and the further ITS station 122. This means that the ITS module 110 is configured for sending the ITS message over at least one of the first ITS station interface and the second ITS station interface towards the ITS station 121. The ITS module 110 further is configured for communicating with the ITS server 130 over the ITS server interface 143.

In some embodiments, referred to as “vehicle-embodiments” herein, the ITS message from the further ITS station 122 is received by the ITS module 110. See action A040 below. However, the ITS station 121 is not able to receive the ITS message, since the ITS station 121 and the further ITS station 122 support different ITS station interfaces, i.e. the first and second ITS station interfaces 141, 142, respectively. In some other embodiments, referred to as “server-embodiments” herein, information relating to an ITS message is received, as in action A040 below, from the ITS server 130. In order to ensure that both the ITS station 121 and the further ITS station 122 are able to receive an ITS message, the ITS module 110 sends the ITS message on both its supported different ITS station interfaces, i.e. the first and second ITS station interfaces 141, 142. The ITS message may be based on, e.g. derived from or generated by use of, the information relating to the ITS message,

In some further embodiments, possibly combined with any one of the embodiments mentioned above, the ITS module 110 may attempt check that, or at least assess whether, the ITS station 121 appears to be present in the vicinity of the ITS module 110, or in particular in the vicinity of the RSU 111. These embodiments are referred to as “monitor-prior-to-transmission-embodiments” herein. This is described in more detail below.

One or more of the following actions may be performed in any suitable order.

### Action A010

According to the monitor-prior-to-transmission-embodiments, the ITS module 110 may receive, at a first time instant, a further ITS message over the first ITS station interface. The ITS module 110 may register, such as store, an indication of the first time instant. In this manner, the ITS module 110 may later retrieve the first time instant in order to use it in e.g. in action A050.

The further ITS message may be received from the ITS station 121 or any other ITS station (not shown) supporting communication via the first ITS station interface.

### Action A020

When the further ITS station 122 e.g. detects an event that any surrounding ITS station may benefit from knowing, the further ITS station 122 may wish to make any surrounding ITS station aware of this event by sending an ITS message. Therefore, according to the vehicle-embodiments, the further ITS station 122 may send the ITS message, e.g. towards the ITS module 110 as well as any surrounding ITS station supporting the second ITS station interface. In this manner, the ITS station 121 may provide information, carried by the ITS message, to any nearby ITS station that supports the second ITS station interface 142.

### Action A030

According to the server-embodiments, the ITS server 130 may send information relating to an ITS message, e.g. towards the ITS module 110. In this manner, the ITS server 130 may provide information, or initiate transmission of information, to any nearby ITS stations. The information relating to the ITS message may encapsulate the ITS message. Alternatively or additionally, the information relating to the ITS message may be a trigger to the ITS module 110, which in turn may generate the ITS message based on the trigger. For example, the trigger may indicate that the ITS module may send an ITS message indicating bad weather or the like.

### Action A040

Subsequent to action A020 and/or A030, the ITS module 110 receives information relating to the ITS message over the second ITS station interface or the ITS server interface. It shall here be noted that the term “information relating to the ITS message” may refer to the ITS message itself or to e.g. the trigger or the like as mentioned above.

In view of the monitor-prior-to-transmission-embodiments, it may be noted that the information relating to the ITS message may be received at a second time instant, where the first time instant precedes the second time instant.

Following action A020, according to the vehicle-embodiments, the ITS module 110 may receive, from the further ITS station 122, the ITS message over only the second ITS station interface.

Following action A030, according to the server-embodiments, the ITS module 110 may receive, from the ITS server 130, the information relating to the ITS message over only the ITS server interface.

### Action A050

According to the monitor-prior-to-transmission-embodiments, the ITS module 110 may decide to perform action A070 below when a difference in time between the first and second time instants is less than a period of time.

In this manner, the ITS module 110 may assess whether or not it is expected that the ITS station 121, i.e. any vehicle not supporting the first ITS station interface 141, is present in the vicinity of the ITS module 110, e.g. in vicinity of the RSU 111. Thus, it may be avoided that the ITS message is sent, or transmitted, in action A070 below when it is considered that no vehicle supporting the first ITS station interface 141 may receive the ITS message. As a result, interference due to the sending of the ITS message may be reduced and spectrum resources may accordingly be saved.

The period of time may be a pre-determined or dynamic threshold value. Typical values of the period of time are e.g. 1 hour, 4 hours, 6 hours, 1 day or the like.

### Action A060

In order to ensure that the ITS message, received in action A040, is received by nearby ITS stations, the ITS module 110 determines to send the ITS message over at least the first ITS station interface when the information relating to the ITS message was received over the second ITS station interface or the ITS server interface.

Expressed differently, the ITS module 110 may find out that the ITS message was received by use of the first ITS technology or the ITS server interface. The ITS module 110 may then determine to send the ITS message over at least the first ITS station interface.

For the vehicle-embodiments, this action may mean that the ITS module 110 may determine to send the ITS message over only the first ITS station interface if, or when, the ITS message was received over only the second ITS station interface. In this manner, the ITS message may, in action A070 below, be provided to the ITS station 121 that only supports the first ITS station interface 141.

For the server-embodiments, this action may mean that the ITS module 110 may determine to send the ITS message over both the first and second ITS station interfaces if, or when, the information relating to the ITS message was received over only the ITS server interface.

This action may further include conversion of the ITS message from one format to another format. With reference to Table 1 above, the term “format” refers to that the ITS message may be formatted according to e.g. CAM, DENM, BSM, SPAT, MAP, HTTP, FTP and/or the like. These formats may be referred to as application layer formats in the context of the present disclosure. The same, or corresponding formats, may be used for LTE V2X PC5.

Therefore, as an example, the ITS module 110 may detect that the ITS message is formatted according to a first format, such as any one of the directly above listed formats. Assume that e.g. LTE V2X PC5, as an example of the first ITS station interface, does not include the first format, but instead LTE V2X PC5 has defined a second format that corresponds to the first format. In this case, the ITS module 110 may convert the ITS message from the first format to the second format before proceeding to action A070.

In another example, the first ITS station interface may be ETSI ITS G5 and the second ITS station interface may be IEEE WAVE. In case the ITS module 110 detects that the format of the received ITS message is BSM, then the ITS module 110 may convert this message into a corresponding ITS message of CAM format before proceeding to action A070. Though, in case the ITS module 110 detects that the format of the received ITS message is e.g. FTP, then no conversion will need to be performed. A reason for this is that FTP is implemented in both IEEE WAVE and ETSI ITS G5 as shown in Table 1.

In this manner, with or without conversion of the ITS message as above, the ITS module 110 takes a role of an interpreter to the first ITS station interface from at least one of the second ITS station interface and the ITS server interface.

### Action A070

Subsequent to action A060, the ITS module 110 sends, towards the ITS station 121, the ITS message over said determined at least the first ITS station interface.

With the vehicle-embodiments, the ITS module 110 sends, towards the ITS station 121, the ITS message over only the first ITS station interface. In this manner, the ITS module 110 enables forwarding of the ITS message, from the further ITS station 122 to the ITS station 121, despite the ITS station 121 and the further ITS station 122 supports different ITS station interfaces.

With the server-embodiments, the ITS module 110 sends, towards the ITS station 121 and a further ITS station 122, the ITS message over both the first and second ITS station interfaces. In this manner, the ITS module 110 ensures that the ITS message is provided to both the ITS station 121 and the further ITS station 122 despite support of different ITS station interfaces.

### Action A080

Subsequent to action A070, the ITS station 121 receives, from the ITS module 110, the ITS message on the determined ITS station interface, such as the first ITS station interface.

As briefly noted in the background section, some regions may deploy one ITS technology and then migrate to another ITS technology. Since vehicles are not replaced as often as e.g. smartphones, there will be some vehicles supporting an older ITS technology and some vehicles supporting a newer ITS technology. It may also be that different RSUs would during an interim period time support either one of the older and newer ITS technology. According to the embodiments herein, transfer of an ITS message from one ITS technology to another ITS technology is achieved. Thus, co-existence of and/or interworking between two different ITS technologies is facilitated.

Moreover, as mentioned initially in this section, vehicles, e.g. including OBUs and/or ITS stations, may move between different regions, deploying different ITS technologies. Even though the vehicles move, they may still need to be able to communicate with infrastructure and other vehicles, regardless if these other vehicles use a different ITS technology or not, in order to be able to take advantage of the ITS system. Thanks to that the embodiments herein facilitates interworking between different ITS technologies, e.g. through different ITS station interfaces, the embodiments allow vehicles to seamlessly move between different regions while still taking advantage of the ITS system.

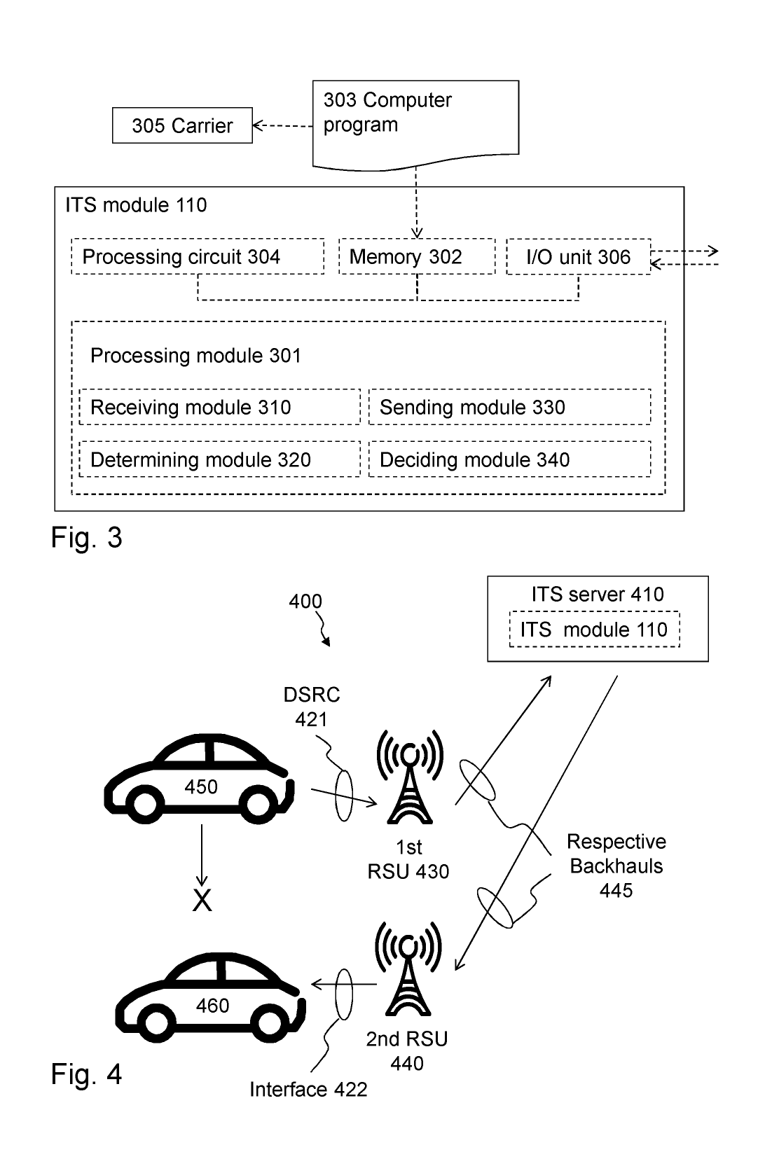

With reference to FIG. 3, a schematic block diagram of embodiments of the ITS module 110 of FIG. 1 is shown.

The ITS module 110 may comprise a processing module 301, such as a means for performing the methods described herein. The means may be embodied in the form of one or more hardware modules and/or one or more software modules

The ITS module 110 may further comprise a memory 302. The memory 302 may comprise, such as contain or store, instructions, e.g. in the form of a computer program 303, which may comprise computer readable code units.

According to some embodiments herein, the ITS module 110 and/or the processing module 301 comprises a processing circuit 304 as an exemplifying hardware module, which may be implemented by one or more processors. Accordingly, the processing module 301 may be embodied in the form of, or ‘realized by’, the processing circuit 304. The instructions may be executable by the processing circuit 304, whereby the ITS module 110 is operative to perform the methods of FIG. 2. As another example, the instructions, when executed by the ITS module 110 and/or the processing circuit 304, may cause the ITS module 110 to perform the method according to FIG. 2.

In view of the above, in one example, there is provided an ITS module 110 for handling an ITS message. As mentioned, the ITS module 110 is configured for sending the ITS message over at least one of a second ITS station interface and a first ITS station interface towards an ITS station 121, wherein the ITS module 110 further is configured for communicating with an ITS server 130 over an ITS server interface. Again, the memory 302 contains the instructions executable by said processing circuit 304 whereby said ITS module 110 is operative for:

receiving information relating to the ITS message over the second ITS station interface or the ITS server interface,

determining to send the ITS message over at least the first ITS station interface when the information relating to the ITS message was received over the second ITS station interface or the ITS server interface, and

sending, towards the ITS station 121, the ITS message over said determined at least the first ITS station interface.

FIG. 3 further illustrates a carrier 305, or program carrier, which comprises the computer program 303 as described directly above.

In some embodiments, the processing module 301 comprises an Input/Output unit 306, which may be exemplified by a receiving module and/or a sending module as described below when applicable.

In further embodiments, the ITS module 110 and/or the processing module 301 may comprise one or more of a receiving module 310, a determining module 320, a sending module 330, and a deciding module 340 as exemplifying hardware modules. In other examples, one or more of the aforementioned exemplifying hardware modules may be implemented as one or more software modules.

Accordingly, the ITS module 110 is configured for handling an ITS message. The ITS module 110 is configured for sending the ITS message over at least one of a second ITS station interface and a first ITS station interface towards an ITS station 121. The ITS module 110 further is configured for communicating with an ITS server 130 over an ITS server interface.

Therefore, according to the various embodiments described above, the ITS module 110 and/or the processing module 301 and/or the receiving module 310 is configured for receiving information relating to the ITS message over the second ITS station interface or the ITS server interface.

The ITS module 110 and/or the processing module 301 and/or the determining module 320 is configured for determining to send the ITS message over at least the first ITS station interface when the information relating to the ITS message was received over the second ITS station interface or the ITS server interface.

Moreover, the ITS module 110 and/or the processing module 301 and/or the sending module 330 is configured for sending, towards the ITS station 121, the ITS message over said determined at least the first ITS station interface.

According to the vehicle-embodiments, the ITS module 110 and/or the processing module 301 and/or the receiving module 310 may be configured for receiving the information relating to the ITS message by receiving, from a further ITS station 122, the ITS message over only the second ITS station interface. In these embodiments, the ITS module 110 and/or the processing module 301 and/or the determining module 320, or a further determining module (not shown), may be configured for determining to send the ITS message over only the first ITS station interface if the ITS message was received over only the second ITS station interface. Additionally, in these embodiments, the ITS module 110 and/or the processing module 301 and/or the sending module 330, or a further sending module (not shown), may be configured for sending the ITS message over only the first ITS station interface.

According to the server-embodiments, the ITS module 110 and/or the processing module 301 and/or the receiving module 310 may be configured for receiving the information relating to the ITS message by receiving, from the ITS server 130, the information relating to the ITS message over only the ITS server interface. In these embodiments, the ITS module 110 and/or the processing module 301 and or the determining module 320, or a yet further determining module (not shown), may be configured for determining to send the ITS message over both the first and second ITS station interfaces if the information relating to the ITS message was received over only the ITS server interface. Furthermore, the ITS module 110 and/or the processing module 301 and/or the sending module 330, or a yet further sending module (not shown), may be configured for sending the ITS message, towards the ITS station 121 and a further ITS station 122, over both the first and second ITS station interfaces.

According to the monitor-prior-to-transmission-embodiments, the ITS module 110 and/or the processing module 301 and/or the receiving module 310, or a yet further receiving module (not shown), may be configured for receiving, at a first time instant, a further ITS message over the first ITS station interface. The information relating to the ITS message was received at a second time instant. The first time instant precedes the second time instant. In these embodiments, the ITS module 110 and/or the processing module 301 and/or the deciding module 340 may be configured for deciding to perform sending of the ITS message when a difference in time between the first and second time instants is less than a period of time.

In some embodiments, the second ITS station interface is associated with a first ITS technology and the first ITS station interface is associated with a second ITS technology. The first ITS technology is different from the second ITS technology.

In some embodiments, the first ITS technology is associated with a first protocol stack and the second ITS technology is associated with a second protocol stack. The first protocol stack is different from the second protocol stack at least in terms of physical layer.

In some embodiments, the ITS module 110 is comprised in a RSU 111 or an OBU 112.

FIG. 4 is a schematic overview illustrating a further exemplifying system 400, comprising an ITS server 410. This example may be briefly explained as that the ITS module 110 of FIG. 1 is located in the ITS server 410.

The system 400 may be an ITS system or the like similarly to the one illustrated in FIG. 1.

The system 400 may be said to comprise the ITS server 410. The ITS server 410 may be located in, or associated, with a local or central cloud platform or the like. In some examples, the ITS server 410 may be co-located with an RSU, such as a DSRC RSU, a LTE User Equipment (UE) RSU, an LTE evolved-NodeB (eNB) RSU or the like. The ITS server 410 may communicate with vehicles via road side units, such as a first RSU 430 and a second RSU 440, interconnected with the ITS server 410 by means of a suitable respective backhaul connection 445, such as a cellular network (not shown) or the like. In this example, the first RSU 430 supports DSRC 421 and the second RSU 440 supports an interface 422, such as LTE V2X PC5. Clearly, none of the first RSU 430 and the second RSU 440 is a multi-mode RSU according to the terminology in relation to FIG. 1.

Furthermore, a first vehicle 450 and a second vehicle 460 are in the vicinity of the first RSU 430 and the second RSU 440, respectively. The first and second vehicles 450, 460 may be provided with a respective ITS station, such as an OBU. The first vehicle 450 supports, thanks to the respective ITS station, e.g. DSRC and the second vehicle 460 supports, also thanks to the respective ITS station, e.g. LTE V2X PC5.

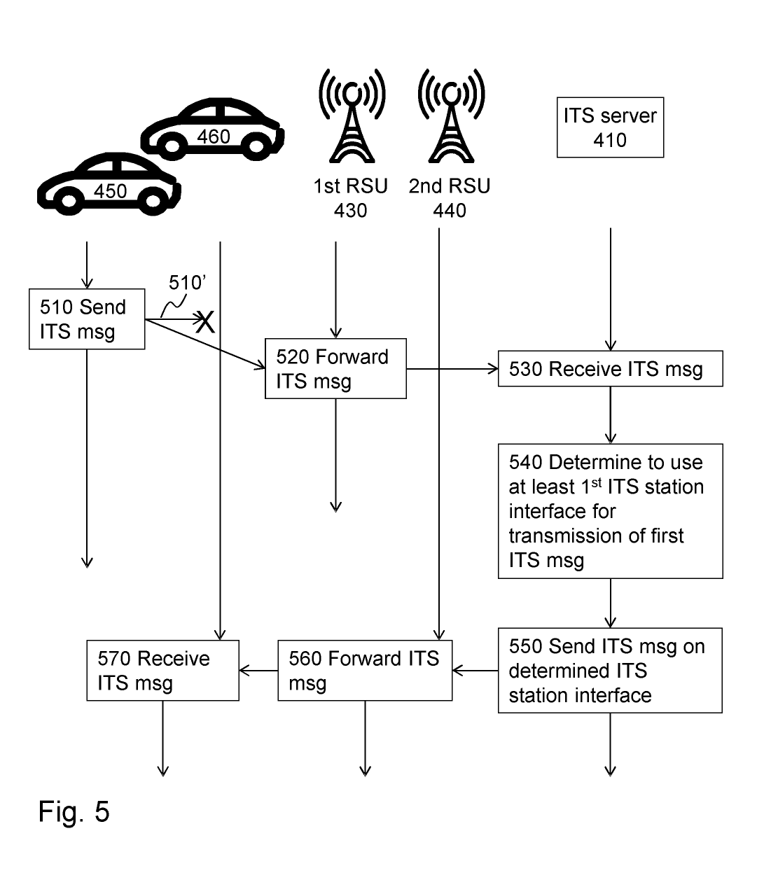

Now turning to FIG. 5, an exemplifying method, performed in the system 400, is described with reference to actions 510 through 570, which may be performed in any suitable order.

### Action 510

Initially, the first vehicle 450 may broadcast an ITS message via DSRC. The ITS message is then received by the first RSU 430, but the ITS message is not received 510′ by the second vehicle 460.

### Action 520

Upon receiving the ITS message, the first RSU 430 forwards the ITS message to the ITS server 410 via its backhaul. The ITS message may be encapsulated into a kind of server message when forwarded to the ITS server 410.

### Action 530

Subsequent to action 520, the ITS server 410 receives the ITS message, which typically is encapsulated as mentioned above.

### Action 540

Now that the ITS server 410 has obtained the ITS message, the ITS server 410 processes the ITS message and may determine, or decide, that the ITS message should be broadcast via another technology, e.g. using the interface 422 of the second RSU 440. This action is similar to action A040 and A060.

### Action 550

Therefore, the ITS server 410 transmits, or sends, the ITS message to the second RSU 440 and instructs the second RSU 440 that the ITS message should be broadcast by the second RSU 440. Again, the ITS message be encapsulated into a suitable server message when the ITS message is received by the second RSU 440. In this manner, the second RSU 440 receives instruction about broadcasting of the ITS message from the ITS server 410.

### Action 560

At this stage, the second RSU 440 forwards the ITS message by broadcasting the ITS message on the interface 420, i.e. using LTE V2X PC5.

### Action 570

Subsequent to action 560, the second vehicle 460 receives the ITS message, since the second vehicle 460 monitors LTE V2X PC5. The second vehicle 460 may act and/or react to the ITS message in any suitable manner.

In summary, the ITS server 410 receives an ITS message, e.g. an encapsulated ITS message or information relating to the ITS message, from the first vehicle 450, such as an ITS station located in a UE, via the 1^{st} RSU 430. When the ITS server 410 knows what ITS station interface is supported by the first vehicle 450, the ITS server 410 may then forward the ITS message, alternatively create a new ITS message based on information of the received ITS message, and transmit the ITS message towards the 2^{nd} RSU 440, i.e. any RSU supporting an ITS station interface that is different from the ITS station interface 421 supported by the first vehicle 450 who sent the ITS message in action 510.

In another example, the second RSU 440 may be an LTE eNB RSU and then the ITS message may be transmitted on a so called Uu interface to the second vehicle 460 instead of LTE V2X PC5 as shown in FIG. 4. In these examples, the second vehicle 460 consequently supports, again thanks to its respective ITS station, LTE Uu interface for communication with the second RSU 440.

Moreover, the ITS server 410 may trigger, as in action 403, transmission of the ITS message using broadcast, such as evolved Multimedia Broadcast Multicast Service (eMBMS), Single-cell Point-to-Multipoint (SC-PTM) or the like.

Alternatively or additionally, the ITS server 410 may also relay and/or forward ITS messages to after-market devices located in older vehicles, e.g. some who may not be able to receive broadcast messages, over direct communication interfaces/links, e.g. using addressing according to any known technology.

As used herein, the term “module” may refer to one or more functional modules, each of which may be implemented as one or more hardware modules and/or one or more software modules and/or a combined software/hardware module. In some examples, the module may represent a functional unit realized as software and/or hardware.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing module” may include one or more hardware modules, one or more software modules or a combination thereof. Any such module, be it a hardware, software or a combined hardware-software module, may be a determining means, estimating means, capturing means, associating means, comparing means, identification means, selecting means, receiving means, sending means or the like as disclosed herein. As an example, the expression “means” may be a module corresponding to the modules listed above in conjunction with the Figures.

As used herein, the term “software module” may refer to a software application, a Dynamic Link Library (DLL), a software component, a software object, an object according to Component Object Model (COM), a software component, a software function, a software engine, an executable binary software file or the like.

As used herein, the term “processing circuit” may refer to a processing unit, a processor, an Application Specific integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the expression “transmit” and “send” are considered to be interchangeable. These expressions include transmission by broadcasting, uni-casting, group-casting and the like. In this context, a transmission by broadcasting may be received and decoded by any authorized device within range. In case of uni-casting, one specifically addressed device may receive and decode the transmission. In case of group-casting, a group of specifically addressed devices may receive and decode the transmission.

As used herein, the terms “number” and/or “value” may be any kind of digit, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the term “set of” may refer to one or more of something. E.g. a set of devices may refer to one or more devices, a set of parameters may refer to one or more parameters or the like according to the embodiments herein.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by an Intelligent Transportation System “ITS” module, for handling an ITS message, wherein the ITS module is configured for sending the ITS message over at least one of a first ITS station interface and a second ITS station Interface towards an ITS station, wherein the ITS module further is configured for communicating with an ITS server over an ITS server interface, wherein the method comprises:
receiving information relating to the ITS message over the second ITS station interface or the ITS server interface,
determining to send the ITS message over at least the first ITS station interface when the information relating to the ITS message was received over the second ITS station interface or the ITS server interface, and
sending, towards the ITS station, the ITS message over said determined at least the first ITS station interface.

2. The method according to claim 1, wherein the receiving of the Information relating to the ITS message comprises receiving, from a further ITS station, the ITS message over only the second ITS station interface,
wherein the determining comprises determining to send the ITS message over only the first ITS station interface if the ITS message was received over only the second ITS station interface, and
wherein the sending of the ITS message comprises sending the ITS message over only the first ITS station interface.

3. The method according to claim 1, wherein the receiving of the information relating to the ITS message comprises receiving, from the ITS servers, the information relating to the ITS message over only the ITS server interface,
wherein the determining comprises determining to send the ITS message over both the first and second TS station interfaces if the information relating to the ITS message was received over only the ITS server interface, and
wherein the sending of the ITS message comprises sending, towards the ITS station nd a further ITS station, the ITS message over both the first and second ITS station interfaces.

4. The method according to claim 1, wherein the method comprises:
receiving, at a first time instant, a further ITS message over the first ITS station interface, wherein the information relating to the ITS message was received at a second time instant, wherein the first time instant precedes the second time instant, and
deciding to perform the sending of the ITS message when a difference in time between the first ad second time instants is less than a period of time.

5. The method according to claim 1, wherein the second ITS station interface is associated with a first ITS technology and the first ITS station Interface is associated with a second ITS technology, wherein the first ITS technology is different from the second ITS technology.

6. The method according to claim 1, wherein the first ITS technology is associated with a first protocol stack and the second ITS technology is associated with a second protocol stack, wherein the first protocol stack is different from the second protocol stack at least in terms of physical layer.

7. The method according to claim 1, wherein the ITS module is comprised in a Road Side Unit “RSU” or an On-Board Unit “OBU”.

8. A computer program, comprising computer readable code units which when executed on an ITS module causes the ITS module to perform the method according to claim 1.

9. A carrier comprising the computer program according to claim 1, wherein the carrier is one of an electronic signal, an optical signal, a radio signal and a computer readable medium.

10. An Intelligent Transportation System “ITS” module configured for handling an ITS message, wherein the ITS module is configured for sending the ITS message over at least one of a second ITS station interface and a first ITS station interface towards an ITS station, wherein the ITS module further is configured for communicating with an ITS server over an ITS server interface, wherein the ITS module is configured for:
receiving information relating to the ITS message over the second ITS station interface or die ITS server interface,
determining to send the ITS message over at least the first ITS station interface when the information relating to the ITS message was received over the second ITS station interface or the ITS server interface, and
sending, towards the ITS station, the ITS message over said determined at least the first ITS station interface.

11. The ITS module according to claim 10, wherein the ITS module is configured for receiving the information relating to the ITS message by receiving, from a farther ITS station, the ITS message over only the second ITS station interface,
wherein the ITS module is configured for determining to send the ITS message over only the first ITS station interface if the ITS message was received over only the second ITS station interface, and
wherein the ITS module is configured for sending the ITS message over only the first ITS station interface.

12. The ITS module according to claim 10, wherein the ITS module is configured for receiving the information relating to the ITS message by receiving, from the ITS server, the information relating to the ITS message over only the ITS server interface,
wherein the ITS module is configured for determining to send the ITS message over both the first and second ITS station interfaces if the information relating to the ITS message was received over only the ITS server interface, and
wherein the ITS module is configured for sending the ITS message, towards the ITS station and a further ITS station, over both the first and second ITS station interfaces.

13. The ITS module according to claim 10, wherein the ITS module is configured for:
receiving, at a first time instant, a further ITS message over the first ITS station interface, wherein the information relating to the ITS message was received at a second time instant, wherein the first time instant precedes the second time instant, and
deciding to perform sending of the ITS message when a difference in time between the first and second time instants is less than a period of time.

14. The ITS module according to claim 10, wherein the second ITS station interface is associated with a first ITS technology and the first ITS station interface is associated with a second ITS technology, wherein the first ITS technology is different from the second ITS technology.

15. The ITS module according to claim 14, wherein the first ITS technology is associated with a first protocol stack and the second ITS technology is associated with a second protocol stack, wherein the first protocol stack is different from the second protocol stack at least in terms of physical layer.

16. The ITS module according to claim 10, wherein the ITS module is comprised in a Road Side Unit “RSU” or an On-Board Unit “OBU”.
